(19) United States
(12) Patent Application Publication
(10) Pub. No.: US 2021/0383458 A1
(43) Pub. Date: Dec. 9, 2021

(54) CROWD SOURCE SHOPPING ENVIRONMENT MAPS AND CUSTOM SHOPPING ROUTE PLANNING

(71) Applicant: International Business Machines Corporation, Armonk, NY (US)

(72) Inventors: Catherine H. CRAWFORD, Bedford, NH (US); John A. GUNNELS, Somers, NY (US); Ramya RAGHAVENDRA, New York, NY (US); Aisha WALCOTT, Nairobi (KE)

(21) Appl. No.: 16/891,985

(22) Filed: Jun. 3, 2020

(51) Int. Cl. G06Q 30/06; G06Q 10/08; G06Q 10/04; G06Q 30/02; G06F 16/903

(52) U.S. Cl. CPC G06Q 30/0639; G06Q 30/0635; G06Q 10/0875; G06Q 50/01; G06Q 30/0281; G06Q 30/0623; G06F 16/90335; G06Q 10/047

(57) ABSTRACT

Techniques for generating shopping routes through shopping environments are provided. A plurality of identified shopping list items are used to generate a shopping list for a user where the shopping list items are based on items the user needs. The shopping list is updated using a processed inventory image which identifies inventory items located in an inventory of the user. Items the user currently has are reduced or removed from the shopping list. When the shopping list is complete, a shopping route through a shopping environment is generated for the shopping list using a crowd-sourced or community updated map to provide an efficient route to the shopping list items in the shopping environment.

### BACKGROUND

The present invention relates to providing guidance to shoppers as they traverse a shopping environment such as a supermarket, and more specifically, to providing a shopper a route through a shopping environment to select and purchase items that are on a shopping list generated for the shopper's needs.

Often shoppers in retail environments will roam through a retail environment while searching for items to purchase. In some examples, the roaming behavior is due to shopper preference to roam while shopping. In other examples, shopper roaming may also be caused by the layout and product placement in shopping environments which often cause a shopper to proceed through many or all aisles and areas of a store for maximum product exposure.

Furthermore, the location and the placement of items may change (e.g., temporary endcap displays, store layout redesigns, rotating stock, etc.) such that consumers may only know of these changes after entering the store and searching for the items. Consumers who would like to efficiently navigate shopping environments due to time or budget constraints are left inefficiently roaming the shopping environments in order to find the desired products.

### SUMMARY

According to one embodiment of the present disclosure, a method is provided. The method includes identifying a plurality of shopping list items to generate a shopping list for a user, processing an inventory image to identify a plurality of current inventory items located in an inventory of the user, and updating the shopping list according to the plurality of current inventory items by removing or reducing an amount for at least one of the plurality of shopping list items in the shopping list. The method also includes generating a shopping route through a shopping environment using the updated shopping list and a community updated map for the shopping environment which includes community source location for a plurality of products in the shopping environment, and during a user traversal of the shopping route in the shopping environment, updating the community updated map with map updates received from the user including at least one location for a product in the shopping environment. Advantageously, the method allows for a user to generate a shopping list including items needed by the user and efficiently navigate a shopping environment to purchase the item. Other embodiments of this aspect include corresponding computer systems, apparatus, and computer programs recorded on one or more computer storage devices, each configured to perform the actions of the methods.

According to another embodiment, the method may include prior to generating the shopping route and upon the user entering the shopping environment, receiving the community updated map for the shopping environment from at least one of a peer device in the shopping environment and a cloud based map repository. The method may also include where updating the community updated map using the map updates received from the user may further include: processing at least one image received from the user to identify at least one product, determining a location of the at least one product, and providing the location and identification of the at least one product to at least one peer device in the shopping environment. Advantageously, this allows for the generated shopping routes to use current information for product locations to generate the shopping routes.

According to another embodiment, the method may further include receiving a shopping list image which includes a recipe from the user. Furthermore, processing the shopping list image may include: identifying one or more shopping list items from the recipe and identifying an item amount for the one or more shopping list items. Adding the plurality of shopping list items to the shopping list may also include: adding the one or more shopping list items from the recipe with the identified item amounts. Advantageously, this allows for the shopping list to include items needed by the user to complete a task such as a recipe.

According to another embodiment, the inventory image may include an at least one image from at least one food storage area. The food storage area may include a refrigerator, a freezer, a pantry, and one or more food storage containers. Furthermore, processing the inventory image may include: identifying one or more current inventory items from the at least one image and identifying an item amount for the one or more current inventory items. In one embodiment, updating the shopping list according to the plurality of current inventory items may include: removing or reducing an amount for the one or more shopping list items with the identified item amounts from the shopping list when the one or more shopping list items are present in the one or more current inventory items. Advantageously, this allows for the shopping list to include only the items needed but not currently held in inventory by the user.

According to another embodiment, the method also includes updating the shopping list according to a user input by adding a manual shopping list item to the shopping list or removing a shopping list item from the shopping list based on the user input. Advantageously, this allows for manual customizations of the shopping list by the user.

According to another embodiment, generating the shopping route through the shopping environment may include: determining one or more user settings for the shopping route from at least one of a user shopping profile and user shopping route inputs and generating the shopping route according to the user settings. Advantageously, this allows for optimizations or customizations of the generated shopping routes according to user needs.

According to another embodiment, the method may also include: receiving at least one contemporaneous shopping route update from at least one peer device in the shopping environment, determining one or more shopping parameters from the at least one contemporaneous shopping route update, and adjusting the shopping route according to the one or more shopping parameters. Advantageously, this provides for continued updating and accuracy of the community updated map.

According to another embodiment, a system is provided. The system includes one or more computer processors and a memory containing a program which when executed by the computer processors performs an operation. The operation may include: identifying a plurality of shopping list items to generate a shopping list for a user, processing an inventory image to identify a plurality of current inventory items located in an inventory of the user, and updating the shopping list according to the plurality of current inventory items by removing or reducing an amount for at least one of the plurality of shopping list items in the shopping list. The operation also includes generating a shopping route through a shopping environment using the updated shopping list and a community updated map for the shopping environment may include community source location for a plurality of products in the shopping environment and during a user traversal of the shopping route in the shopping environment, updating the community updated map with map updates received from the user may include at least one location for a product in the shopping environment.

According to still another embodiment, a computer program product is provided. The computer program product a computer-readable storage medium having computer-readable program code embodied therewith, the computer-readable program code executable by one or more computer processors to perform an operation. The operation may include: identifying a plurality of shopping list items to generate a shopping list for a user, processing an inventory image to identify a plurality of current inventory items located in an inventory of the user, and updating the shopping list according to the plurality of current inventory items by removing or reducing an amount for at least one of the plurality of shopping list items in the shopping list. The operation may also include generating a shopping route through a shopping environment using the updated shopping list and a community updated map for the shopping environment may include community source location for a plurality of products in the shopping environment, and during a user traversal of the shopping route in the shopping environment, updating the community updated map with map updates received from the user may include at least one location for a product in the shopping environment.

### BRIEF DESCRIPTION OF THE SEVERAL VIEWS OF THE DRAWINGS

FIG. 1A illustrates an example shopping list image, according to one embodiment.

FIG. 1B illustrates example inventory images, according to one embodiment.

FIG. 1C illustrates an example shopping list, according to one embodiment.

FIG. 2 illustrates an example shopping environment, according to one embodiment.

FIG. 3 illustrates a system to facilitate a shopping route and community updated map, according to one embodiment.

FIG. 4 illustrates example shopping route options in a shopping environment, according to one embodiment.

FIG. 5 illustrates a flowchart for generating a shopping list and shopping route and updating a community updated map, according to embodiments.

FIG. 6 illustrates a flowchart for generating a shopping list, according to embodiments.

FIG. 7 illustrates a flowchart for shopping route generation, according to embodiments.

FIG. 8 illustrates a block diagram of a system, according to embodiments.

### DETAILED DESCRIPTION

Consumers in retail environments often encounter large amounts of advertisements and other retail methods to persuade or induce a shopper to purchase more items. For example, product placement of commonly bought items within a store may be spread over the entire shopping environment which results in consumers or shoppers traversing or traveling through most or all of the shopping environment during most trips to the store. For example, in a grocery store or supermarket environment, frequently purchased items such as bread and milk may be located at opposite ends of the store such that a shopper walks or travels through a majority of the store layout or floor space to select the items for purchase. During this time traveling through the shopping environment, the shopper may pass advertisements and products placed to attract the attention of the shopper and ultimately persuade the shopper to purchase additional items.

While some shoppers may prefer to spend time in the shopping environment and purchase additional items, shoppers who are budget-conscious or constrained on time that can be spent shopping may prefer to traverse a retail store as quickly as possible and select only those items needed. For example, a shopper with a shopping list may prefer to only visit locations within the shopping environment.

Furthermore, locations of items within shopping environment are often hard to find either because a shopping environment is unfamiliar to the shopper or because item locations within a known shopping environment can frequently change. For example, item locations in a shopping environment may be changed for a promotion, store remodeling, etc. Additionally, a shopper searching for an item he or she does not typically purchase can be left searching for the item in wrong areas of the store, etc.

Previous methods for assisting shoppers in shopping environments rely on store provided information. For example, a retail store provides shoppers locations of individual items within a particular store. However, these methods often only provide one location for one item at a time and do not offer a user any insight onto how to traverse the store to reach of the item locations as they are searched. Additionally, this information can be out-of-date and leave a shopper searching in wrong locations for items.

The methods and systems described herein provide both insight into products needed by a shopper/consumer as well as providing a shopping route through a shopping environment to select and collect the identified products for purchase. In some examples described herein, the system processes a shopping list image received from a consumer to identify shopping list items for a shopping list, removes any items in the shopping list that are in the consumers current inventory, and generates a shopping route through a shopping environment using the updated shopping list and a community updated map for the shopping environment. The community updated map includes a maps that is sourced and updated by peer devices in a shopping environment as described herein.

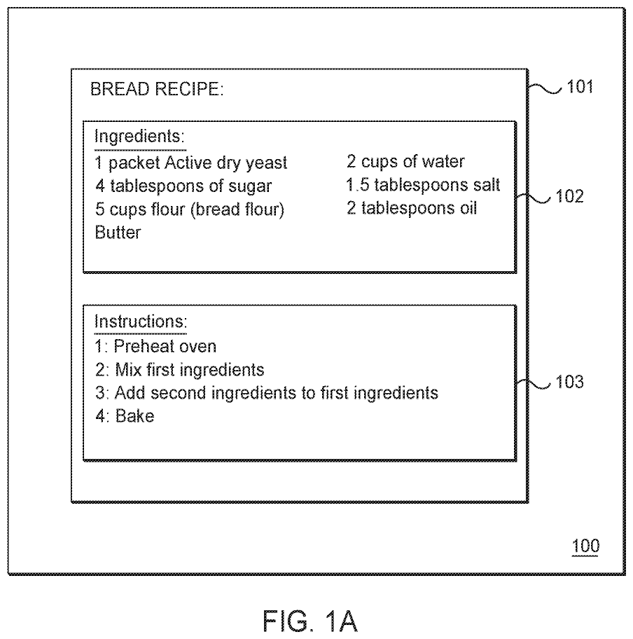

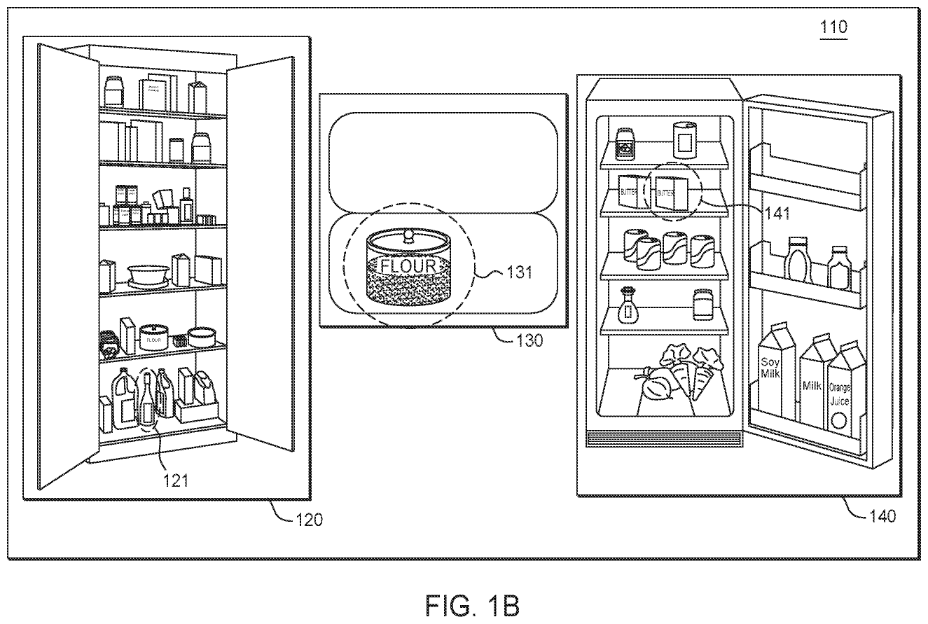

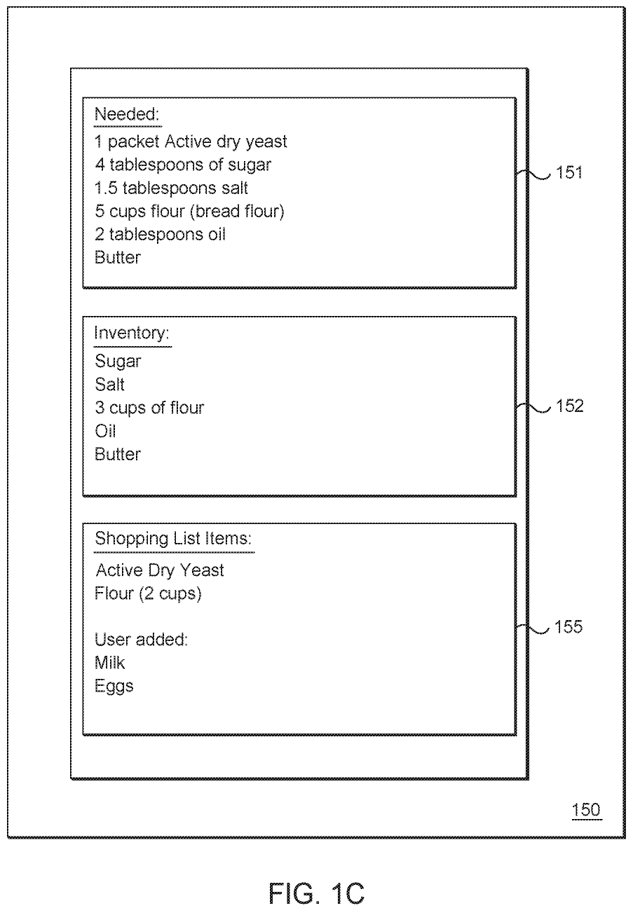

FIG. 1A illustrates an example shopping list image 100, according to one embodiment. In some examples, the shopping list image 100 is picture or image of a recipe 101, where the recipe 101 includes a list of ingredients 102 and a set of instructions 103. While shown as a recipe in FIG. 1A, the shopping list image 100 may include an image of any list or collection of shopping items needed by a user. For example, the shopping list image 100 may include any of a list of components needed in a set of instructions, a hand written shopping list, a suggested list of items for a purpose (recipe, manual instructions), etc. In some examples, a user captures the shopping list image 100 using a user device camera. For example, the user takes a picture of the recipe 101 using the camera on the user device such as a smart phone or other mobile device. Further, while described as a picture or image, the shopping list image 100 may also include other data forms, such as a recipe, list, etc. provided to the user device (e.g., a recipe downloaded from the Internet, etc.).

The user device processes the shopping list image 100 using image processing and text recognition techniques to identify various sections and components in the shopping list image 100. For example, the user device identifies various sections of the recipe 101 in the shopping list image 100, the section including the list of ingredients 102 and the set of instructions 103. The user device also processes the list of ingredients 102 to identify shopping list items needed for the recipe and given amounts for each item. For example, the user device, using image processing techniques, identifies from the recipe 101 that the recipe calls for 1 packet of Active dry yeast, 2 cups of water, 4 tablespoons of sugar, 1.5 tablespoons of salt, 5 cups of flour (which may be bread flour), 2 tablespoons oil, and 1 tablespoon of butter. In some examples, all of these identified items are added to a shopping list as discussed in relation to FIG. 1C.

In some examples, some items may be automatically excluded from a shopping list according to settings including user defined settings. For example, water of any amount may be excluded since it is typically available from a water source in a home. Other items may also be automatically excluded or added to the shopping list according to other user preferences or settings described herein. Additionally, the user may already have some of the items in inventory, where the user does not need to purchases all of the items that are in the ingredient list. In order to efficiently add or subtract ingredients to the shopping list, the user utilizes the user device to obtain an inventory image.

FIG. 1B illustrates example inventory images 110, according to one embodiment. The inventory images 110 include inventory images 120, 130, and 140. The inventory image 120 includes an image of a pantry, the inventory image 130 includes an image of a cupboard including a food storage container 131, and the image 140 includes an image of a refrigerator/freezer. Each of the inventory images 120, 130, and 140 may be taken individually by user or as a single image which captures each of the images at one time. In another example, the images are provided by cameras on other devices and sent to the user device. For example, network connected internet-of-things devices such as an image/camera device at the pantry or refrigerator, etc. may provide an inventory image to the user device for the various food storage (inventory storage) locations.

The user device processes the inventory images 110 to determine the presence of inventory items. For example, oil 121 is present in the pantry as shown in inventory image 120, and butter 141 is present in the refrigerator as shown in image 140. In these examples, the user device identified these items in the images and removes the identified inventory items from the shopping list since the user does not to purchase these items for the recipe 101.

In some examples, the user device also determines an item amount for the inventory items. For example, the food storage container 131 may contain flour, but an amount less than required by the recipe 101 in FIG. 1A. In this example, the user device reduces an amount of the item in the shopping list based on how much of the item is present in the inventory. For example, when three cups of flour are in the inventory, the associated shopping list item is reduced down to two cups from five cups to account for the flour in the inventory as shown in FIG. 1C.

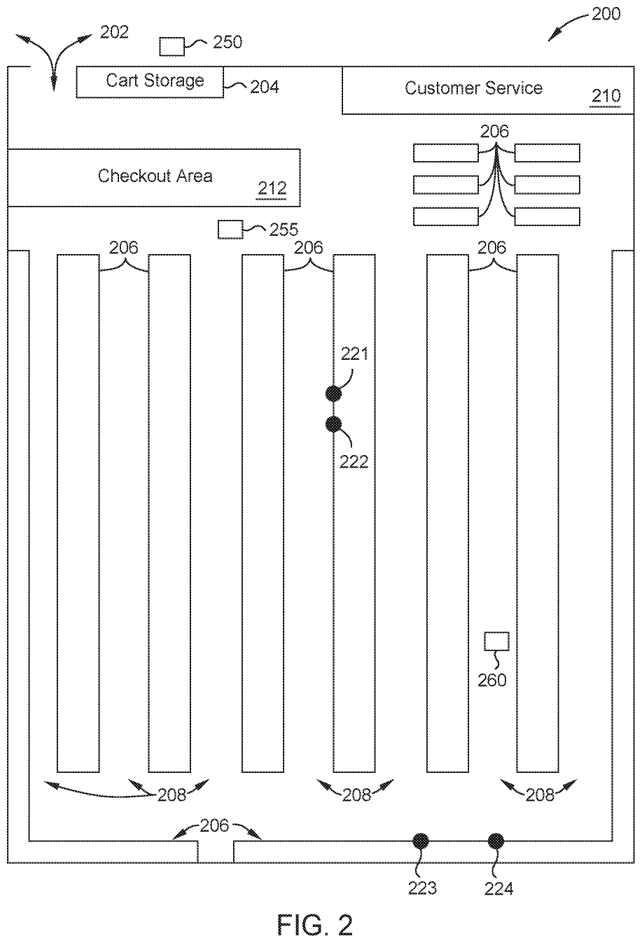

FIG. 1C illustrates an example shopping list 150, according to one embodiment. In some examples, the shopping list 150 includes a needed items 151, inventory items 152, and shopping list items 155. The needed items 151 include items that are added from the recipe 101 and additional items that may be manually added by a user. The inventory items 152 include any items that are in stock such as those recognized in the processes described in FIG. 1B in the inventory items. In some examples, as items are added to the needed items 151 the items are also added to the shopping list items 155. When the items in the needed items 151 are also in the inventory items 152, the needed items may be removed from or modified in the shopping list items 155. For example, butter 141 may be removed from the shopping list items 155 and flour may be modified or reduced to 2 cups (since 3 cups are present in the inventory items 152). In some examples, alternate items may also be added to the shopping list items 155. For example, bread flour as a substitute or alternative to flour may be included in the flour item in the shopping list items 155. As the shopping list items 155 are finalized, the shopping list 150 is used to generate a shopping route in a shopping environment such as described in relation to FIGS. 2-4.

FIG. 2 illustrates an example shopping environment, environment 200, according to one embodiment. The environment 200 may include a retail store or other environment where a shopper, consumer, customer or user may traverse the environment in search of items for purchase. Retail stores may include supermarkets, grocery stores, hardware stores, department stores, etc. The environment 200 may include sections 206 where items for purchase are located. For example, the sections 206 may include shelves, endcaps, and other displays for products/items for purchase. Additionally, the environment 200 includes aisles 208 between the sections 206 where customers, employees, and others may travel between the aisles and other sections 206. For example, customers may navigate the aisles 208 and approach, view, handle, and select items in the sections 206. In some examples, a user may traverse or travel through the environment represented by the environment 200 with a shopping receptacle (shopping carts, baskets, or other containers) and select items for purchase by placing the items in the shopping receptacle where a purchase of the selected items is finalized in a checkout area 212.

In some examples, the environment 200 includes one or more entrances and exits, such as entrance/exit 202, an area for cart storage, e.g., cart storage area 204, and a customer service area 210 where a user can interact with an employee or customer service representative for shopping environment as needed. In some examples, as a user approaches the environment 200 with a user device 250, the user device 250 receives a map and or layout of the environment 200 from one or more peer user devices, such as user device 255 and user device 260. The community updated map provided by the peer user devices may include the most up to date or current map available for the environment 200 including any product location changes or other updates to the environment 200. The user device 250 uses the map received from the peer user devices to identify item locations for the items in the shopping list 150 including locations 221, 222, 223, and 224 in the environment 200.

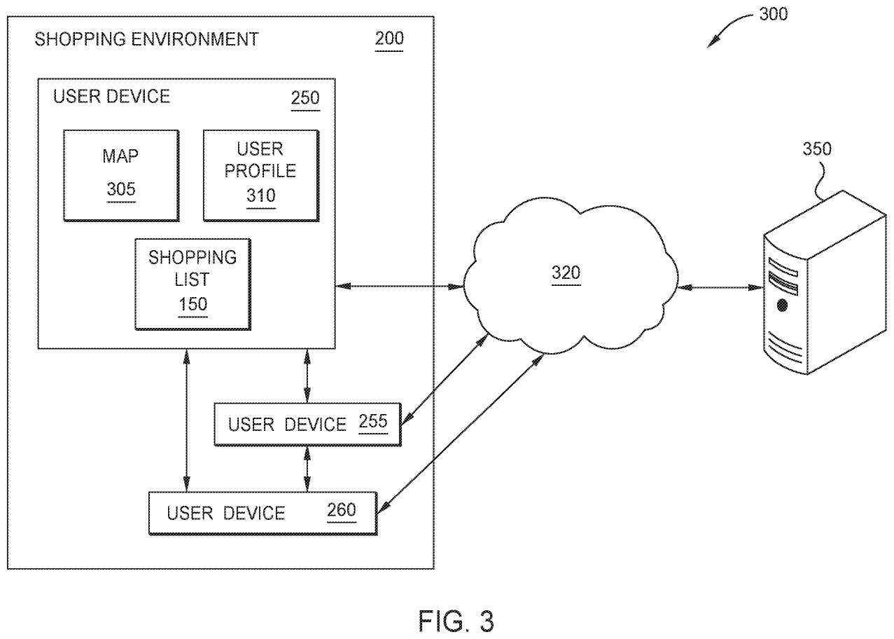

FIG. 3 illustrates a system 300 to facilitate a shopping route and community updated map, according to one embodiment. As illustrated and shown in FIG. 2, the system 300 may include various components within the environment 200, including the user devices 250, 255, and 260. As shown, the user devices 250, 255, and 260 may be in direct communication with each other via various mobile communication protocols and may also connect to and communicate via a network 320. The system 300 may also include components that are outside the environment 200. For example, a server 350 may be located remotely from the environment 200, such as in a cloud computing system or a central control center for the shopping environment or the community updated map system.

Server 350 generally includes processor(s), memory, and communications capabilities and is configured to perform various computing tasks to support the management and operation of the community updated map as well as facilitating peer devices generation of shopping routes and updates to community updated maps in the environment 200. Server 350 may communicate using various wired and/or wireless communications methods with the peer devices, such as user devices 250, 255, and 260, and with other networked devices. In some examples, the server 350 generally executes computer program code in which input data is received from the networked devices, the input data is processed and/or stored by the servers, and output data is provided to networked devices such as the user device 250.

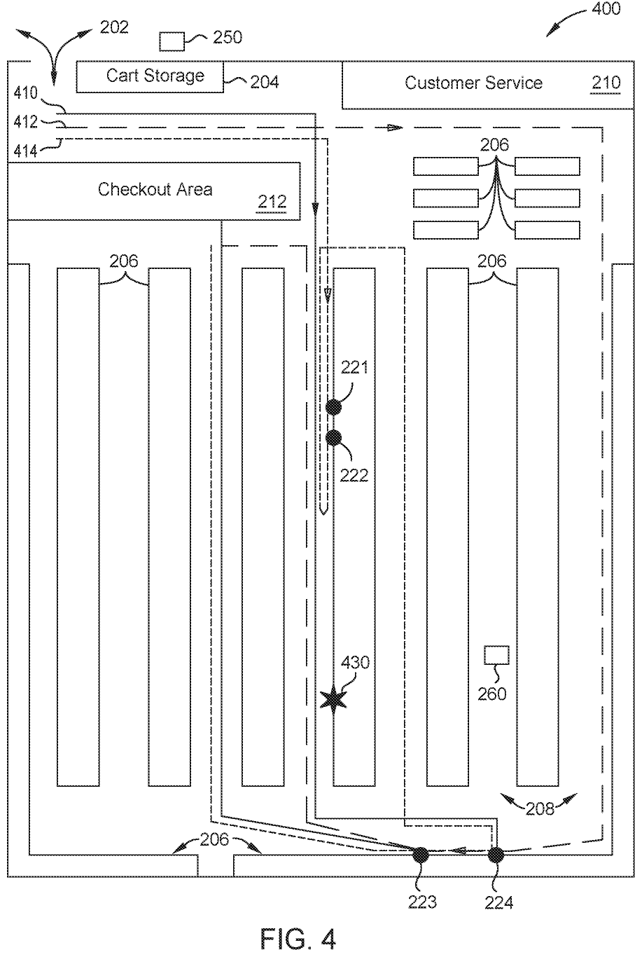

Network 320 may include one or more networks of various types, including a local area or local access network (LAN), a general wide area network (WAN), and/or a public network (e.g., the Internet). In one embodiment, various networked computing devices of the system 300 are interconnected using a LAN, and one or more computing devices (e.g., server 350, user device 250, etc.) include connections to the Internet. In some examples, the user device 250 including the shopping list 150 as described in relation to FIG. 1C and the updated community map, map 305, received from the peer devices and a user profile 310. In some examples, the system 300 and the user device 250 generate various shopping routes through the environment 200 as described in relation to FIG. 4.

FIG. 4 illustrates example shopping route options in a shopping environment, according to one embodiment. The user device 250 using the map 305, received from either the peer devices or the server 350 as described in FIG. 3, and the shopping list items 155 in the shopping list 150, generates at least one shopping route through the environment 200. For example, the user device 250 generates a shopping route 410 which proceeds through the environment 200 in order from the entrance/exit 202 to the location 221, the location 222, the location 224, the location 223, to the checkout area 212. In some examples, the shopping route 410 is the most direct and efficient route through the environment 200 that visits all the item locations. In some examples, the user device 250 uses the most direct and efficient route as the default setting for routes generated for the environment 200.

In some examples, a user may set various user settings in the user profile 310 for the generating of shopping routes in the environment 200 and/or shopping routes in general (e.g., for shopping routes through any shopping environment). For example, the user may indicate that certain areas of the environment 200 should be avoided. For example, a user with food allergies may desire to avoid sections of the store where the allergens are located. For example, location 430 in the environment 200 may include items that are to be avoided by the user as indicated in user shopping profile, the user profile 310. In this example, the user device 250 generates shopping route 414 which proceeds in the same order for visiting item locations as the shopping route 410, but avoids passing the location 430 in order to avoid user exposure to whichever items may be present at location 430. In another example, the location 430 may be an update or note on the map 305 which indicates that the location 430 is a closed section (e.g., the section is closed for restocking, cleaning, etc.) and the user device 250 generates the shopping route 414 based on the map 305 to avoid the location 430.

In another example, the user settings may include settings to maximize a shopping route's distance or prioritize a certain product as first, etc. For example, the user device 250 generates the shopping route 412 in order to pass the customer service area 210 and to visit location 224 first based on the various settings in the user profile 310.

In each of the shopping routes 412, 412, and 414, the shopping route proceeds to each location where the items on the shopping list 150 are located such that the user can select an item from the location. In some examples, the user also updates the community updated map stored on the user device, the map 305, at each of the item locations and other locations in the environment 200. For example, when an item is out of stock or its location has changed, etc., the user using the user device 250 updates the map 305 with an indication of the change. For example, the user using the user device 250 may take a photo of the item location, the location 221, including any items at the location 221, and the user device 250 processes the image received from a user to identify at least one product in the image. The user device also determines a location of the at least one product, stores the update in the map 305, and provides the location and identification of the at least one product to at least one peer device in the shopping environment. For example, when an item at the location 221 is out-of-stock, moved locations, or other updates or changes, the user device 250 updates the map 305 with the updated information and transmits the updated information to other peer devices such as the user device 260.

In one example, the user device 250 receives contemporaneous shopping route updates from a peer device in the shopping environment. For example, while the user is traversing one of the shopping routes 410, 412, or 414, the user device 250 receives an update from the user device 260 which indicates that an item location has changed or sold out, an area of the store is closed, etc. The user device 250 determines one or more shopping parameters (item has changed location, store section closed, etc.) from the contemporaneous shopping route and adjusts the shopping route according to the one or more shopping parameters. For example, the user device 250 may drop the location 223 from the shopping route 410 in an example where the item on the shopping list items 155 at the location 223 is sold out. In another example, when the location of the item at location 223 has changed, the user device 250 adds the new location to the shopping route 410.

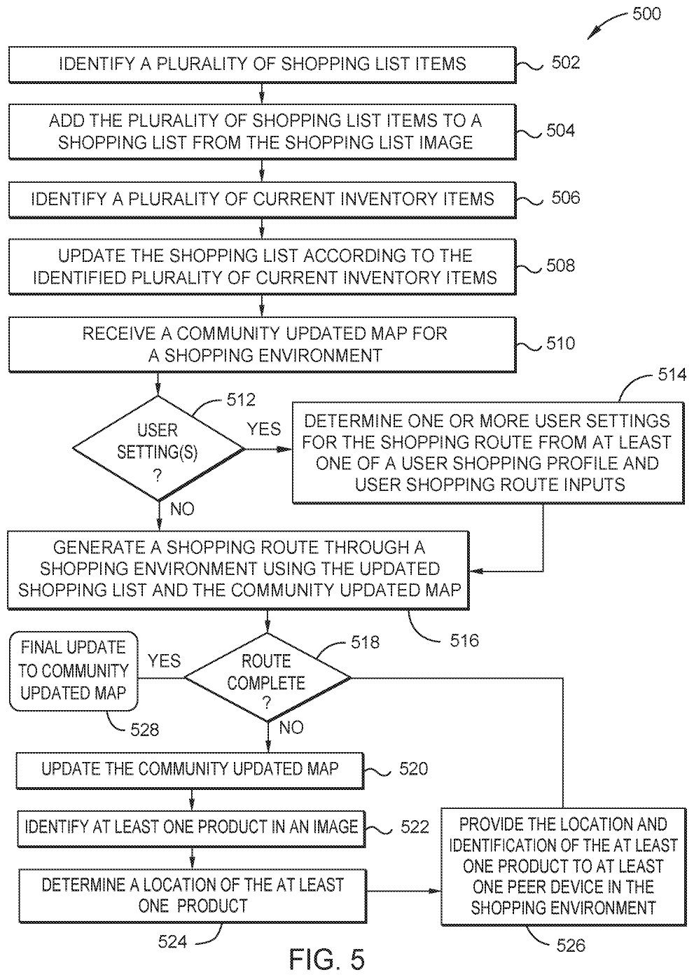

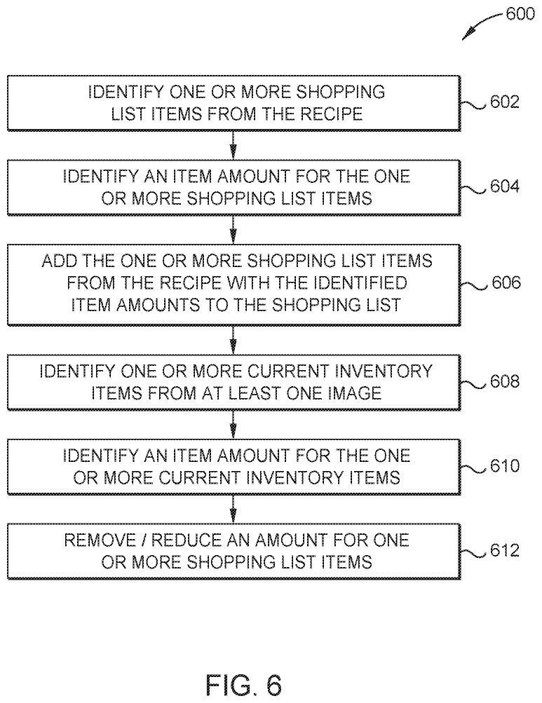

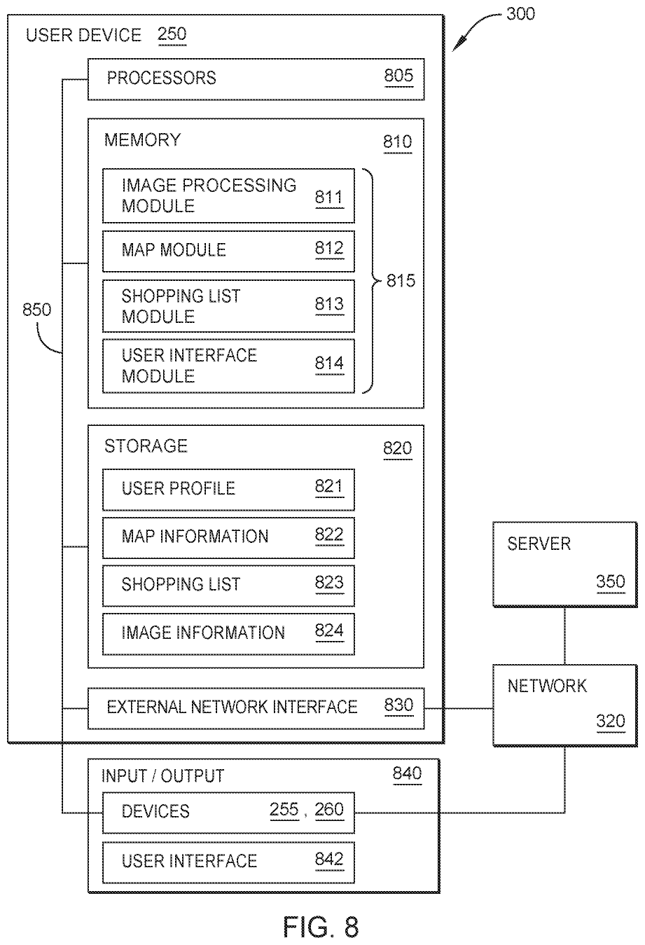

FIG. 5 illustrates a flowchart for generating a shopping list, shopping route, and updating a community updated map, according to embodiments. For ease of discussion the methods described in FIGS. 5-7 will refer the examples and systems described in FIGS. 1A-4. The methods may also be performed by the user device 250 described in FIGS. 2-3 as well as FIG. 8. Method 500 begins at block 502, where the user device 250 processes a shopping list image received from a user to identify a plurality of shopping list items. For example, a user captures a shopping list image 100 using a camera or other image taking means on the user device 250. The shopping list image 100 may include a list of components needed in a set of instructions, a hand written shopping list, a suggested list of items for a purpose, etc. As shown in FIG. 1A, the user device captures shopping list image 100 which includes the recipe 101. The user device 250, using image and text recognition processes identifies various items in the shopping list image 100 to identify items needed by the user or other items that are to be added to a shopping list. For example, for the recipe 101, the user device identifies the ingredients 102 including the items 1 packet of Active dry yeast, 2 cups of water, 4 tablespoons of sugar, 1.5 tablespoons of salt, 5 cups of flour which may be bread flour, and 2 tablespoons oil, and 1 tablespoon of butter. In some examples, as the items are identified/recognized as needed items, the items are added to a needed items 151 and stored for further use by the user device 250. Identifying items for the shipping list is discussed in greater detail in relation to a method 600 described in FIG. 6.

At block 504, the user device 250 adds the plurality of shopping list items to a shopping list. As the user device 250 identifies and determines which items should be added to a shopping list from the shopping list image 100, the user device 250 add the items to the shopping list items 155 shown in FIG. 1C. In some examples, the user updates the shopping list items 155 by providing a user input to the user device 250. The user input may include inputs to the user device to add a manual shopping list item (e.g., an item not identified from the shopping list image 100) to the shopping list items 155 and/or an input to remove a shopping list item (e.g. an item not needed or already known to be in inventory, etc.) from the shopping list items 155. The user device 250 updates the shopping list items 155 according to the user inputs by adding the manual shopping list item to the shopping list items 155 or removing the shopping list item from the shopping list items 155 based on the user input.

At block 506, the user device 250 processes an inventory image to identify a plurality of current inventory items. For example, a user captures the inventory images 110 (including inventory images 120, 130, and 140) using a camera or other image taking means on the user device 250. The inventory images 110 may include an image of any items that are currently available to a user or not needed from a store or shopping environment. As shown in FIG. 1B, the user device captures inventory images 110, 120, 130, and 140 which include images of a pantry, cupboard, and refrigerator. The user device 250, using image and text recognition processes identifies various inventory items from the inventory images and stores the items in the inventory list 152 as shown in FIG. 1C. Identifying inventory is discussed in greater detail in relation to the method 600 described in FIG. 6.

At block 508, the user device 250 updates the shopping list according to the plurality of current inventory items. For example, as described in relation to FIG. 1C, the items on the needed items 151 and/or the shopping list items 155 that are present in the inventory items 152 are removed from the shopping list items 155 or the amount needed is reduced from the shopping list items 155. This aids a user from overbuying items or buying unnecessary or unneeded item. In some examples, the user may also manually update the shopping list to adjust items needed and or add additional items related to the shopping list image 100 (e.g., related to the recipe 101) or unrelated to the shopping list image 100 (e.g., items needed by the user for other reasons or used).

At block 510, the user device 250 receives a community updated map for a shopping environment from at least one of a peer device in the shopping environment and a cloud based map repository. For example, the user device 250 may receive the community updated map, map 305 from peer devices including one of the user devices 255 and 260 when a user approaches and/or enters the environment 200, e.g. approaches the entrance/exit 202 shown in FIG. 2. In some examples, the map 305 provided from the peer devices includes up to date information including any updates that have been made to the map of the environment 200 by the user devices 255 and 260. In some examples, the map 305 may not be available from the peer devices when the user enters the environment 200 and/or an up-to-date version of the map 305 may be stored on the server 350 such that the user device 250 requests the map 305 from the server 350 and receives the map via the network 320. In some examples, the user device 250 receives the community updated map prior to generating various shopping routes as described in relation to block 516.

At block 512, the user device 250 determines whether user settings are stored in a user profile for the shopping environment or whether the user has provided specific inputs for a current shopping trip. For example, the user device 250 determines from the user profile 310 whether the user has input any settings for the environment 200 or for generating shopping routes in general. In an example where the user profile 310 contains user settings for the environment 200 or the user has inputted settings, method 500 proceeds to block 514, where the user device 250 determines one or more user settings for generating a shopping route from at least one of a user shopping profile and user shopping route inputs. For example, user settings and/or a user input may specify that a generated shopping route should minimize time in the environment 200. The user settings and/or the user input may also specify that the generated shopping route avoid specific sections of the store (e.g., unwanted items and/or allergies, etc.).

At block 516, the user device 250 generates a shopping route through a shopping environment using the updated shopping list, the community updated map for the shopping environment, and user settings determined at block 514 (if present). For example, the user device 250 generates the shopping route 410 which includes routes to each location for the items in the shopping list items 155 and to the checkout area 212 in the environment 200.

In some examples, the shopping route 410 is generated as a default shopping route through the environment 200 and the shopping routes 412 and 414 are shopping routes that are alternate shopping routes and/or routes generated using the user settings in the user profile 310 or user inputs as discussed in relation to block 514. For example, the shopping route 414 avoids the location 430 according to the user settings and the shopping route 412 provides a longer route to the various locations according to the user settings. The user device 250 may provide the routes to a user via visual, auditory, or other output means while a user is shopping or traversing the environment 200. The user device may also provide a current location of the user device 250 to the user while traversing the environment 200.

As the user is shopping in the environment 200, the user device 250 at block 518 determines whether a user has completed traversing the generated shopping route. For example, the user device 250 determines, using position and other location information whether the user device 250 has visited each location in the route and/or followed the generated shopping route provided to the user. In another example, the user device 250 being present in the checkout area 212 indicates that the shopping trip is completed.

While the location of the user device 250 indicates the user is still shopping the method 500 continues to block 520, where the user device 250 updates the community updated map using map updates received from the user during a user traversal of the shopping route in the shopping environment. In some examples, the user updates may include manual updates received from the user via the user device 250. For example, a user may input that an item is not in a location and/or updates the location of the item. In some examples, the user input may include other information received at the user device 250 such as images or scans received at the user device 250.

For example, at block 522, the user device 250 processes at least one image received from the user to identify at least one product. For example, as the user traverses the environment 200, whenever an item is selected by the user, the user may also take a picture of the item location and the item. For example, at the location 221, the user takes a picture of the location using the user device 250. The user device 250 processes the image to identify at least one product in the image. For example, the user device 250 may identify more examples of the product just selected by the user and/or other items near the location (e.g., other items on the shelf etc.). In some examples, when the identified product is in the shopping list, the user device 250 updates the shopping list items 155 as the item being selected.

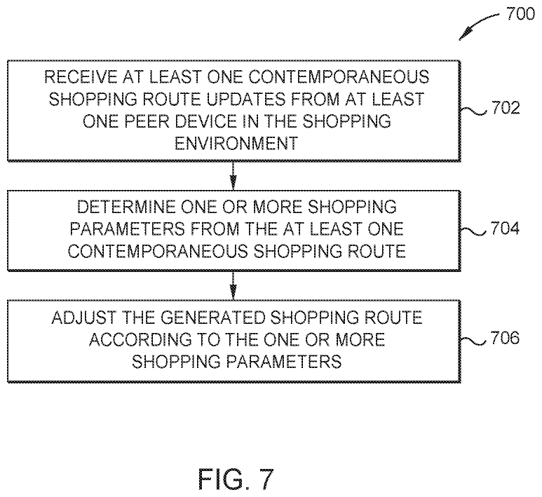

At block 524, the user device 250 determines a location of the at least one product identified in the block 522. For example, the user device 250 using positioning information within the environment 200 identifies the location of the user device 250, e.g., location 221. At block 526, the user device 250 stores the identified product and location in the map 305 and provides the location and identification of the at least one product to at least one peer device in the shopping environment (e.g., provides the updated map the peer devices in the environment 200). This process allows for the various peer devices including the user device 250 to maintain current up-to-date maps of the shopping environment throughout a shopping experience. In some examples, the user device 250 also receives updates during the traversal of the environment 200 and updates shopping routes as described in relation to method 700 of FIG. 7.

Returning back to block 518, when a user has completed traversing the environment 200 (e.g., the user device is at the checkout area 212 or exiting through the entrance/exit 202), the user device 250 provides a final update to the community updated map at block 528. For example, the user device sends the updated map 305 to one or more peer devices in the environment 200 and/or to the server 350.

FIG. 6 illustrates a flowchart for generating a shopping list, according to embodiments. In some examples, the shopping list image includes a recipe. The recipe may include a food recipe or other type of instructions for a task. At block 602, the user device 250 identifies one or more shopping list items from the recipe and identifies an item amount for the one or more shopping list items at block 604. For example as described in relation to FIG. 1A, the user device 250 identifies from the recipe 101 that the recipe calls for 1 packet of Active dry yeast, 2 cups of water, 4 tablespoons of sugar, 1.5 tablespoons of salt, 5 cups of flour (which may be bread flour), 2 tablespoons oil, and 1 tablespoon of butter.

At block 606, the user device 250 adds the one or more shopping list items from the recipe with the identified item amounts. For example, as shown in FIG. 1C, the needed items 151 are added to the shopping list items 155 including the amounts such as 5 cups of flour, etc.

At block 608, the user device 250 identifies one or more current inventory items from at least one image. In some examples, the at least one image includes an inventory image from at least one food storage area. For example, the at least one food storage area may include a refrigerator, a freezer, a pantry, and one or more food storage containers.

The user device 250 processes the inventory image by identifying an item amount for the one or more current inventory items at block 610 and updates the shopping list according to the plurality of current inventory items by removing or reducing an amount for the one or more shopping list items with the identified item amounts from the shopping list when the one or more shopping list items are present in the one or more current inventory items at block 612. For example, the user device 250 removes the identified oil 121 from the shopping list items 155 and reduces the amount flour needed from 5 cups to 2 cups to account for the 3 cups in the inventory (e.g., inventory items 152).

FIG. 7 illustrates a flowchart for shopping route generation, according to embodiments. At block 702, the user device 250 receives at least one contemporaneous shopping route update from at least one peer device in the shopping environment. For example, the peer device, user device 260, transmits an updated map or other information to the user device 250 with any changes in the environment 200 stored at the user device 260.

At block 704, the user device 250 determines one or more shopping parameters from the at least one contemporaneous shopping route update. For example, the user device 250 determines one or more shopping parameters (item has changed location, store section closed, etc.) from the contemporaneous shopping route and adjusts the shopping route according to the one or more shopping parameters.

At block 706, the user device 250 adjusts the shopping route according to the one or more shopping parameters. For example, the user device 250 may drop the location 223 from the shopping route 410 in an example where the item on the shopping list items 155 at the location 223 is sold out. In another example, when the location of the item at location 223 has changed, the user device 250 adds the new location to the shopping route 410.

FIG. 8 illustrates a block diagram of a system 300, according to one embodiment. The user device 250 is shown in the form of a general-purpose computing device. The components of user device 250 may include, but are not limited to, one or more processing units or processors 805, a memory 810, a storage system 820, network interface 830, and a bus 850 that couples various system components including the memory 810 and storage system 820 to processors 805 along with various input/output (I/O) components 840. In other embodiments, system 300 is distributed and includes a plurality of discrete computing devices that are connected through wired or wireless networking.

Bus 850 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

User device 250 typically includes a variety of computer system readable media. Such media may be any available media that is accessible by user device 250, and it includes both volatile and non-volatile media, removable and non-removable media. Memory 810 can include computer system readable media in the form of volatile memory, such as random access memory (RAM) and/or cache memory. User device 250 may further include other removable/non-removable, volatile/non-volatile computer system storage media. By way of example, storage system 820 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 850 by one or more data media interfaces. As will be further depicted and described below, memory 810 may include at least one program product having a set (e.g., at least one) of program modules that are configured to carry out the functions of embodiments of this disclosure.

User device 250 may further include other removable/non-removable, volatile/non-volatile computer system storage media. In some examples, storage system 820 may be included as part of memory 810 and may typically provide a non-volatile memory for the networked computing devices, and may include one or more different storage elements such as Flash memory, a hard disk drive, a solid state drive, an optical storage device, and/or a magnetic storage device. For example, storage system 820 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 850 by one or more data media interfaces. Storage system 820 may include media for storing user profile 821, map information 822, shopping list 823, and image information 824. The storage system 820 may be updated and accessed by program modules 815 described herein.

Memory 810 may include a plurality of program modules 815 for performing various functions described herein. The program modules 815 generally include program code that is executable by one or more of the processors 805. As shown, program modules 815 include image processing module 811, map module 812, shopping list module 813, and user interface module 814.

User device 250 may also communicate with one or more external devices user interface devices 842, providing a user interface, such as a keyboard, a pointing device, a display, etc.; and one or more devices that enable a user to such as interact with user device 250; and/or any devices (e.g., network card, modem, etc.) that enable user device 250 to communicate with one or more other computing devices. Such communication can occur via I/O components 840. Additionally, user device 250 may communicate with one or more networks such as a local area network (LAN), a general wide area network (WAN), and/or a public network (e.g., the Internet) via network interface 830. As depicted, network interface 830 communicates with the other components of user device 250 via bus 850. It should be understood that although not shown, other hardware and/or software components could be used in conjunction with user device 250. Examples, include, but are not limited to: cloud computing systems, microcode, device drivers, redundant processing units, external disk drive arrays, RAID systems, tape drives, and data archival storage systems, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications or related data available in the cloud.

While the foregoing is directed to embodiments of the present invention, other and further embodiments of the invention may be devised without departing from the basic scope thereof, and the scope thereof is determined by the claims that follow.

What is claimed is:

1. A method comprising:
identifying a plurality of shopping list items to generate a shopping list for a user;
processing an inventory image to identify a plurality of current inventory items located in an inventory of the user;
updating the shopping list according to the plurality of current inventory items by removing or reducing an amount for at least one of the plurality of shopping list items in the shopping list;
generating a shopping route through a shopping environment using the updated shopping list and a community updated map for the shopping environment comprising community source location for a plurality of products in the shopping environment; and
during a user traversal of the shopping route in the shopping environment, updating the community updated map with map updates received from the user comprising at least one location for a product in the shopping environment.

2. The method of claim 1, further comprising:
prior to generating the shopping route and upon the user entering the shopping environment, receiving the community updated map for the shopping environment from at least one of a peer device in the shopping environment and a cloud based map repository, and
wherein updating the community updated map using the map updates received from the user further comprises:
processing at least one image received from the user to identify at least one product;
determining a location of the at least one product; and
providing the location and identification of the at least one product to at least one peer device in the shopping environment.

3. The method of claim 1, wherein the method further comprises receiving a shopping list image comprising a recipe from the user, and
wherein processing the shopping list image comprises:
identifying one or more shopping list items from the recipe; and
identifying an item amount for the one or more shopping list items, and
wherein adding the plurality of shopping list items to the shopping list comprises:
adding the one or more shopping list items from the recipe with the identified item amounts.

4. The method of claim 3, wherein the inventory image comprises an at least one image from at least one food storage area comprising:
a refrigerator,
a freezer,
a pantry, and
one or more food storage containers;
wherein processing the inventory image comprises:
identifying one or more current inventory items from the at least one image;
identifying an item amount for the one or more current inventory items; and
wherein updating the shopping list according to the plurality of current inventory items comprises:
removing or reducing an amount for the one or more shopping list items with the identified item amounts from the shopping list when the one or more shopping list items are present in the one or more current inventory items.

5. The method of claim 1, further comprising:
updating the shopping list according to a user input by adding a manual shopping list item to the shopping list or removing a shopping list item from the shopping list based on the user input.

6. The method of claim 1, wherein generating the shopping route through the shopping environment comprises:
determining one or more user settings for the shopping route from at least one of a user shopping profile and user shopping route inputs; and
generating the shopping route according to the user settings.

7. The method of claim 1, further comprising:
receiving at least one contemporaneous shopping route update from at least one peer device in the shopping environment;
determining one or more shopping parameters from the at least one contemporaneous shopping route update; and
adjusting the shopping route according to the one or more shopping parameters.

8. A system comprising:
one or more computer processors; and
a memory containing a program which when executed by the computer processors performs an operation comprising:
identifying a plurality of shopping list items to generate a shopping list for a user;
processing an inventory image to identify a plurality of current inventory items located in an inventory of the user;
updating the shopping list according to the plurality of current inventory items by removing or reducing an amount for at least one of the plurality of shopping list items in the shopping list;
generating a shopping route through a shopping environment using the updated shopping list and a community updated map for the shopping environment comprising community source location for a plurality of products in the shopping environment; and
during a user traversal of the shopping route in the shopping environment, updating the community updated map with map updates received from the user comprising at least one location for a product in the shopping environment.

9. The system of claim 8, wherein the operation further comprises:
prior to generating the shopping route and upon the user entering the shopping environment, receiving the community updated map for the shopping environment from at least one of a peer device in the shopping environment and a cloud based map repository, and
wherein updating the community updated map using the map updates received from the user further comprises:
processing at least one image received from the user to identify at least one product;
determining a location of the at least one product; and
providing the location and identification of the at least one product to at least one peer device in the shopping environment.

10. The system of claim 8, wherein the operation further comprises receiving a shopping list image comprising a recipe from the user, and
wherein processing the shopping list image comprises:
identifying one or more shopping list items from the recipe; and
identifying an item amount for the one or more shopping list items, and
wherein adding the plurality of shopping list items to the shopping list comprises:
adding the one or more shopping list items from the recipe with the identified item amounts.

11. The system of claim 10, wherein the inventory image comprises an at least one image from at least one food storage area comprising:
a refrigerator,
a freezer,
a pantry, and
one or more food storage containers;
wherein processing the inventory image comprises:
identifying one or more current inventory items from the at least one image;
identifying an item amount for the one or more current inventory items; and
wherein updating the shopping list according to the plurality of current inventory items comprises:
removing or reducing an amount for the one or more shopping list items with the identified item amounts from the shopping list when the one or more shopping list items are present in the one or more current inventory items.

12. The system of claim 8, wherein the operation further comprises:
updating the shopping list according to a user input by adding a manual shopping list item to the shopping list or removing a shopping list item from the shopping list based on the user input.

13. The system of claim 8, wherein generating the shopping route through the shopping environment comprises:
determining one or more user settings for the shopping route from at least one of a user shopping profile and user shopping route inputs; and
generating the shopping route according to the user settings.

14. The system of claim 8, wherein the operation further comprises, wherein the operation further comprises:
receiving at least one contemporaneous shopping route update from at least one peer device in the shopping environment;
determining one or more shopping parameters from the at least one contemporaneous shopping route update; and
adjusting the shopping route according to the one or more shopping parameters.

15. A computer program product, the computer program product comprising:
a computer-readable storage medium having computer-readable program code embodied therewith, the computer-readable program code executable by one or more computer processors to perform an operation, the operation comprising:
identifying a plurality of shopping list items to generate a shopping list for a user;
processing an inventory image to identify a plurality of current inventory items located in an inventory of the user;
updating the shopping list according to the plurality of current inventory items by removing or reducing an amount for at least one of the plurality of shopping list items in the shopping list;
generating a shopping route through a shopping environment using the updated shopping list and a community updated map for the shopping environment comprising community source location for a plurality of products in the shopping environment; and
during a user traversal of the shopping route in the shopping environment, updating the community updated map with map updates received from the user comprising at least one location for a product in the shopping environment.

16. The computer program product of claim 15, wherein the operation further comprises:
prior to generating the shopping route and upon the user entering the shopping environment, receiving the community updated map for the shopping environment from at least one of a peer device in the shopping environment and a cloud based map repository, and
wherein updating the community updated map using the map updates received from the user further comprises:
processing at least one image received from the user to identify at least one product;
determining a location of the at least one product; and
providing the location and identification of the at least one product to at least one peer device in the shopping environment.

17. The computer program product of claim 15, wherein the operation further comprises receiving a shopping list image comprising a recipe from the user, and
wherein processing the shopping list image comprises:
identifying one or more shopping list items from the recipe; and
identifying an item amount for the one or more shopping list items, and
wherein adding the plurality of shopping list items to the shopping list comprises:
adding the one or more shopping list items from the recipe with the identified item amounts.
wherein the inventory image comprises an at least one image from at least one food storage area comprising:
a refrigerator,
a freezer,
a pantry, and
one or more food storage containers;
wherein processing the inventory image comprises:
identifying one or more current inventory items from the at least one image;
identifying an item amount for the one or more current inventory items; and
wherein updating the shopping list according to the plurality of current inventory items comprises:
removing or reducing an amount for the one or more shopping list items with the identified item amounts from the shopping list when the one or more shopping list items are present in the one or more current inventory items.

18. The computer program product of claim 15, wherein the operation further comprises:
updating the shopping list according to a user input by adding a manual shopping list item to the shopping list or removing a shopping list item from the shopping list based on the user input.

19. The computer program product of claim 15, wherein generating the shopping route through the shopping environment comprises:
determining one or more user settings for the shopping route from at least one of a user shopping profile and user shopping route inputs; and
generating the shopping route according to the user settings.

20. The computer program product of claim 15, wherein the operation further comprises:
receiving at least one contemporaneous shopping route update from at least one peer device in the shopping environment;
determining one or more shopping parameters from the at least one contemporaneous shopping route update; and
adjusting the shopping route according to the one or more shopping parameters.
